(19) United States
(12) Patent Application Publication
(10) Pub. No.: US 2026/0152602 A1
(43) Pub. Date: Jun. 4, 2026

(54) HYDROLYSIS-RESISTANT POLYESTER-CONTAINING COMPOSITIONS

(71) Applicant: LANXESS Deutschland GmbH, Cologne (DE)

(72) Inventor: Wilhelm Laufer, Ellerstadt (DE)

(73) Assignee: LANXESS Deutschland GmbH, Cologne (DE)

(21) Appl. No.: 19/121,590

(22) PCT Filed: Oct. 20, 2023
(86) PCT No.: PCT/EP2023/079295

§ 371 Date: Apr. 16, 2025

(30) Foreign Application Priority Data
Oct. 27, 2022 (EP) 22203983.6

(51) Int. Cl. C08G 63/183; C08L 67/03

(52) U.S. Cl. CPC C08G 63/183; C08L 67/03

(57) ABSTRACT

The invention relates to hydrolysis-stabilized polyethylene terephthalate (PET)- and/or polylactic acid (PLA)-containing compositions comprising monomeric carbodiimides of the formula (I)

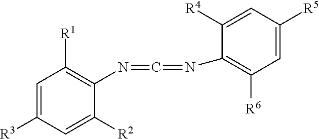

where R¹, R², R⁴ and R⁶=ethyl and
where R³, R⁵ are each independently C₁-C₆-alkyl,
and to processes for preparation of and to the use of these carbodiimides.

The invention relates to hydrolysis-stabilized polyester-containing compositions such as polyethylene terephthalate (PET)-containing and polylactic acid (PLA)-containing compositions, to processes for production thereof and to the use thereof.

PET is used for fibres, for moulding compounds for production of plastics products such as drinks bottles, and also for production of films, for example for electrical insulation and solar cells.

The water content of PET generally supplied by the manufacturer in granulate form for further processing is of the order of magnitude of 0.2 to 0.4% (2000 to 4000 ppm); the moisture content here and its distribution on the surface of the granulate and within the interior of the granulate depend on the crystallinity of the PET in the granulate, and on its composition.

Because the “natural” moisture content of a commercially available PET granulate leads to hydrolytic PET degradation during production of a PET melt, and this affects the quality of the final products obtained, the procedure for the production of high-quality PET products usually includes crystallization, by heating, of the moist PET granulate obtained from the manufacturer, followed by thorough drying. Particularly when biaxially stretched PET films are to be used as capacitor films, films for magnetic recording media, X-ray film substrates, or for graphic-arts applications, there is a requirement for films with excellent optical and mechanical properties together with high surface quality and high homogeneity. In order to achieve these properties, it is necessary to achieve maximum effectiveness in restricting hydrolytic degradation during processing.

PET is particularly susceptible to hydrolysis when it is molten at high temperatures. In contrast, finished products made of solid PET after solidification have almost no significant sensitivity to moisture. However, in order to prevent deterioration of fibre quality during service life of the textile manufactured therefrom, PET usually comprises, as additive, a hydrolysis stabilizer which in particular comprises carbodiimide groups and is generally polymeric. The polycarbodiimide compound is present in homogeneous dispersion in quantities of about 1 to 2.5% by weight in the finished PET fibre, and binds traces of water that penetrate into the fibre and that could lead to partial PET hydrolysis with gradual deterioration of quality. These hydrolysis stabilizers serve exclusively to improve the long-term stability of the finished PET products.

When polymeric carbodiimides are compared with monomeric carbodiimides, however, they have disadvantages because they are less reactive at relatively low temperatures and are difficult to disperse in the polymer matrix, requiring use of specialized technical equipment under relatively aggressive process conditions.

Some monomeric carbodiimides, for example 2,6-bis(diisopropylcarbodiimide), in turn have the drawback of being toxic or insufficiently effective. Further monomeric aromatic carbodiimides having strong steric hindrance are very effective in the PET but first have to be produced, as described in EP 3686240 for example, by means of additional complex and costly downstream purification processes, for example recrystallizations or multiple distillations. Monomeric carbodiimides having lower steric hindrance as described in CN 108912014 are very reactive as acid scavengers in polyester polyols but show inadequate long-term hydrolysis stabilization in PET.

In most biobased aliphatic polyesters, for example polylactic acid (polylactide, PLA) as well, by contrast, most monomeric carbodiimides on their own are insufficiently effective.

It was therefore an object of the present invention to provide improved hydrolysis-stabilized PET and PLA compositions that do not have the aforementioned drawbacks, i.e. show very good protective action against hydrolysis, are easy and inexpensive to produce and are non-toxic.

It has been found that this object is achieved, surprisingly, by a composition comprising polyethylene terephthalate (PET) and/or polylactic acid (PLA) and at least one monomeric carbodiimide of the formula (I)

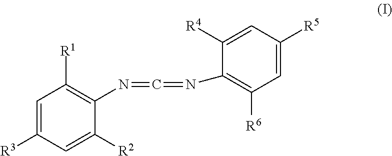

where R¹, R², R⁴ and R⁶ are ethyl and
where R³, R⁵ are each independently C₁-C₆-alkyl.

The C₁-C₆-alkyl radicals of the carbodiimides of the formula (I) used may be linear and/or branched.

In a preferred embodiment, R³ and R⁵ are independently selected from t-butyl, i-propyl and methyl.

In a particularly preferred embodiment, R³ and R⁵ are each methyl, i.e. the carbodiimide conforms to formula (II):

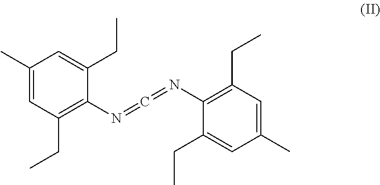

The present invention further provides for the use of the above monomeric carbodiimides of the formula (I) for hydrolysis stabilization of PLA and/or PET.

The carbodiimides used in the present invention preferably have an NCN content of 8% to 13% by weight, preferably 11% to 13% by weight.

The carbodiimides used in the present invention are preferably preparable by carbodiimidization of trisubstituted benzene isocyanates of the formulae (III) and (IV)

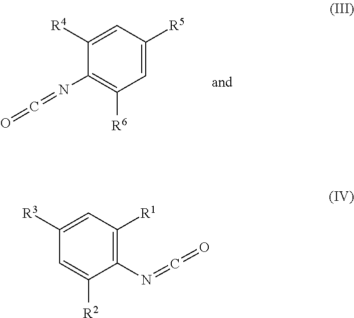

where R¹, R², R⁴ and R⁶ are ethyl and
where R³, R⁵ are each independently C₁-C₆-alkyl, preferably t-butyl, i-propyl or methyl, and most preferably methyl,
at temperatures of 40° C. to 200° C. in the presence of catalysts and optionally solvents, with elimination of carbon dioxide.

A preferred trisubstituted benzene isocyanate used is 2,6-diethyl-4-methylphenyl isocyanate. The trisubstituted benzene amines needed for preparation of the above compounds—as is known to those skilled in the art—can be prepared by Friedel-Crafts alkylation of aniline with the appropriate alkene, haloalkane, haloalkenebenzene and/or halocycloalkane.

These compounds are then reacted with phosgene to give the corresponding trisubstituted benzene isocyanate.

The carbodiimidization is preferably effected by the processes described in Angew. Chem. 93, pp. 855-866 (1981) or DE-A-11 30 594 or Tetrahedron Letters 48 (2007), pp. 6002-6004.

In a preferred embodiment of the invention, catalysts used for the preparation of the compounds of the formula (I) are strong bases or phosphorus compounds. Preference is given to using phospholene oxides, phospholidines or phospholine oxides and also the corresponding sulfides. Further catalysts that may be used are tertiary amines, basic metal compounds, alkali metal and alkaline earth metal oxides, hydroxides, alkoxides or phenoxides, metal carboxylates and non-basic organometallic compounds.

The carbodiimidization can be conducted either in neat form or in a solvent.

It is also likewise possible to prepare the carbodiimides to be used in the process according to the invention from the corresponding trisubstituted anilines by reaction with CS₂ to give the thiourea derivative, followed by conversion in basic hypochlorite solutions to the carbodiimide, or by the process described in EP 0597382 A.

The crude products are preferably purified by a distillation. In a further preferred embodiment, the distillation of the carbodiimide may be preceded or followed, preferably followed, by an extraction with solvent. Suitable solvents used are preferably alcohols, ketones, nitriles, ethers, esters or mixtures of these substances. Particular preference is given to alcohols from the group of the aliphatic monoalcohols, for example methanol, ethanol or isopropanol, most preferably methanol.

In the extraction, the carbodiimide is typically first stirred in at least one solvent at temperatures of preferably 40-80° C., more preferably at 50-60° C. While stirring, the mixture is then cooled to preferably 10-25° C., more preferably to 15-20° C. Subsequently, the two liquid phases are removed. The carbodiimide is then freed of the residual solvent in a stirred tank, preferably at 50-100 C, by distillation and dispensed in liquid form.

In a further embodiment, in addition to the distillation, a recrystallization is conducted after the distillation. Suitable solvents used for the recrystallization are preferably alcohols, more preferably mixtures of these substances. Particular preference is given to alcohols from the group of the aliphatic monoalcohols, for example methanol, ethanol or isopropanol.

The composition according to the invention is produced by mixing PET and/or PLA and monomeric carbodiimide of the formula (I), preferably by means of solids metering and mixing units.

Solids metering and mixing units in the context of the invention are: single-, twin- and multi-screw extruders, continuous co-kneaders (Buss-type) and batch kneaders, e.g. Banbury-type, and other units conventionally used in the polymer industry.

The concentration of the carbodiimides of the formula (I) based on the total amount of PET and/or PLA in the compositions according to the invention or in the use according to the invention is typically 0.5-5% by weight, preferably 0.7-2% by weight, more preferably 1.0-1.5% by weight.

The PET in the context of the invention is any of the polyethylene terephthalates that derive from terephthalic acid (or from its reactive derivatives) and from alkanediols based on ethylene glycol. These likewise include modified polyethylene terephthalate (copolymers).

Preferred polyethylene terephthalates contain at least 80 mol %, preferably at least 90 mol %, based on the dicarboxylic acid, of terephthalic acid residues and at least 80 mol %, preferably at least 90 mol %, based on the diol component, of ethylene glycol residues.

Preferred polyethylene terephthalates also include copolyesters produced from at least two acid components and/or from at least two alcohol components; particularly preferred copolyesters are poly(ethylene glycol/butane-1,4-diol) terephthalates.

Particular preference is given to polyethylene terephthalates produced solely from terephthalic acid and its reactive derivatives, e.g. its dialkyl esters, and ethylene glycol. Polylactic acid preferably comprises aliphatic polyester resins, the monomers of which are obtained by fermentation of starch, sugars or carbohydrates. Polylactic acid is commercially available, for example from Nature Works or TotalEnergies Corbion, and can be produced by the methods familiar to the person skilled in the art, for example ring-opening polymerization of lactides. The preparation of polylactic acid by ring-opening polymerization of lactides is not limited to either of the two enantiomers, L-lactic acid or D-lactic acid, or mixtures thereof. In the context of the invention, the polymers of L-lactic acid and/or D-lactic acid are usable.

In relation to production of the composition composed of PET and/or polylactic acid (PLA) and of the monomeric carbodiimide of the formula (I) in solids metering and mixing units, reference is made to the statements above.

The present invention further provides for the use of the compositions according to the invention for production of shaped bodies, especially for production of mono- and multifilaments, fibres, injection mouldings and films.

The invention further encompasses shaped bodies, especially mono- and multifilaments, fibres, injection mouldings and films, comprising the compositions according to the invention or obtainable by use of the compositions according to the invention.

The scope of the invention encompasses all hereinabove and hereinbelow recited radical definitions, indices, parameters and elucidations, which are of a general nature or are mentioned in preferred ranges, in any combination with one another, i.e. including between the respective ranges and preferred ranges.

The examples that follow serve to elucidate the invention, without having any limiting effect.

### WORKING EXAMPLES

1) Stabilizer A: a monomeric carbodiimide having an NCN content of about 10.8% by weight, based on 2,6-diisopropylphenyl isocyanate, available from Lanxess Deutschland GmbH under the Stabaxol® I name.
2) Stabilizer B: a monomeric carbodiimide having an NCN content of about 8.7% by weight, based on 2,4,6-triisopropylphenyl isocyanate, conforming to the formula

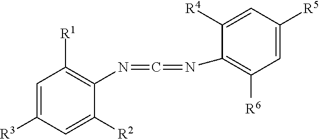

where R¹, R², R⁴, R³, R⁵ and R⁶ are isopropyl
3) Stabilizer C: a monomeric carbodiimide having an NCN content of about 13% by weight, based on 2,6-diethylphenyl isocyanate
4) Stabilizer D: a monomeric carbodiimide having an NCN content of about 12% by weight, based on 2,6-diethyl-4-methylphenyl isocyanate, conforming to the formula (II)
5) PET available from Novapet S.A: with an intrinsic viscosity of about 0.6.
6) PLA available from TotalEnergies Corbion (Luminy 130)
7) TPU available from Covestro Deutschland AG (Desmopan)

### Production of Stabilizers a, B, C and D Used

A baked-out, nitrogen-filled 500 ml flanged flask was charged under a nitrogen stream with 400 g of isocyanate and heated to 140° C. 400 mg of 1-methylphospholene oxide was added, and then the reaction mixture was heated to 160° C. within a period of 5 hours. The reaction was then continued at 160° C. until an NCO content <1% (corresponding to conversion >95%) had been achieved. The crude product thus obtained was purified as follows:
a) Stabilizers A, C and D by distillation.
b) Stabilizer B additionally by recrystallization in a methanol/ethanol mixture (1:1).

### Hydrolysis Stabilization in PET

Hydrolysis-stabilizing efficacy in PET was assessed by dispersing the stabilizers used (stabilizers A, B, C and D) in a concentration of 1.5% by weight in PET by means of a ZSK 25 laboratory twin-screw extruder from Werner & Pfleiderer, prior to the test described below. F3 standard test specimens for measurement of ultimate tensile strength were then produced from the resultant granulates in an Arburg Allrounder 320 S 150-500 injection moulding machine.

For the hydrolysis test, these F3 standard test specimens were stored in water at a temperature of 90° C., and their relative ultimate tensile strength was measured in %. For most applications, a relative ultimate tensile strength above 70% is needed.

Table 1 shows relative tensile strength as percentage, beginning with 100% at day 0.

TABLE 1

| | | Ex. 2 | Ex. 3 | Ex. 4 | Ex. 5 |
|---|---|---|---|---|---|
| Relative | Ex. 1 | (comp.) | (comp.) | (comp.) | (inv.) |
| ultimate tensile | (comp.) | PET, | PET, | PET, | PET, |
| strength (%) | PET | stabilizer A | stabilizer B | stabilizer C | stabilizer D |
| 0 days | 100 | 100 | 100 | 100 | 100 |
| 7 days | 49 | 80 | 79 | 82 | 92 |
| 12 days | — | 50 | 36 | 54 | 71 |
| 16 days | | 30 | — | 20 | 50 |
| 18 days | | — | | — | 37 |

comp. = comparative example,
inv. = inventive

The results show that inventive stabilizer D shows improved hydrolysis stability at the same dosage compared to the monomeric carbodiimides (stabilizer A, stabilizer B and stabilizer C) described in the prior art.

### Hydrolysis Stabilization in PLA

Hydrolysis-stabilizing efficacy in PLA was assessed by dispersing the stabilizers used (stabilizers A and D) in a concentration of 1% by weight in PLA (Luminy L150 from TotalEnergies Corbion) by means of a ZSK 25 laboratory twin-screw extruder from Werner & Pfleiderer, prior to the test described below. F3 standard test specimens for measurement of ultimate tensile strength were then produced from the resultant granulates in an Arburg Allrounder 320 S 150-500 injection moulding machine.

For the hydrolysis test, these F3 standard test specimens were stored in water at a temperature of 65° C., and their relative ultimate tensile strength was measured in %.

Table 2 shows relative tensile strength as percentage, beginning with 100% at day 0.

TABLE 2

| Relative | | Ex. 7 | Ex. 8 |
|---|---|---|---|
| ultimate | Ex. 6 | (comp.) | (inv.) |
| tensile | (comp.) | PLA, | PLA, |
| strength (%) | PLA | stabilizer A | stabilizer D |
| 0 days | 100 | 100 | 100 |
| 7 days | — | 100 | 100 |
| 16 days | | 79 | 91 |
| 25 days | | 50 | 73 |
| 28 days | | 30 | 51 |
| 27 days | | — | 30 |

comp. = comparative example,
inv. = inventive

The results show that inventive stabilizer D shows improved hydrolysis stability at the same dosage compared to the monomeric carbodiimide (stabilizer A) described in the prior art.

HYDROLYSIS stabilization in TPU

Hydrolysis-stabilizing efficacy in thermoplastic polyurethane elastomer (TPU) was assessed by dispersing the stabilizers used (stabilizers A, B and D) in a concentration of 1.5% by weight in TPU (Desmopan 2587A from Covestro Deutschland AG) by means of a ZSK 25 laboratory twin-screw extruder from Werner & Pfleiderer, prior to the test described below. 70% F3 standard test specimens for measurement of ultimate tensile strength were then produced from the resultant granulates in an Arburg Allrounder 320 S 150-500 injection moulding machine.

For the hydrolysis test, these 70% F3 standard test specimens were stored in water at a temperature of 90° C., and their relative ultimate tensile strength was measured in Y %.

TABLE 3

| | | Ex. 10 | Ex. 11 | Ex. 12 |
|---|---|---|---|---|
| Relative | Ex. 9 | (comp.) | (comp.) | (inv.) |
| ultimate tensile | (comp.) | TPU, | TPU, | TPU, |
| strength (%) | TPU | stabilizer A | stabilizer B | stabilizer D |
| 0 days | 100 | 100 | 100 | 100 |
| 7 days | 30 | 80 | 80 | 60 |
| 14 days | — | 70 | 65 | 20 |
| 19 days | | 61 | 57 | — |
| 24 days | | 51 | 50 | |
| 28 days | | 20 | — | |

comp. = comparative example,
inv. = inventive

The results show that stabilizer D shows inadequate hydrolysis stability in the TPU compound at the same dosage compared to the monomeric carbodiimides (stabilizers A and B) described in the prior art.

1. A composition comprising polyethylene terephthalate (PET) and/or polylactic acid (PLA) and at least one monomeric carbodiimide of formula (I) 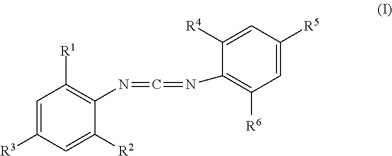
where R¹, R², R⁴ and R⁶=ethyl and
where R³, R⁵ are each independently C₁-C₆-alkyl.

2. The composition according to claim 1, wherein R³ and R⁵ are t-butyl, i-propyl or methyl.

3. The composition according to claim 1, wherein R³ and R⁵ are methyl.

4. The composition according to claim 1, wherein a proportion of the carbodiimide of formula (I), based on the total amounts of PET and/or PLA, is 0.5-5% by weight.

5. A process for producing the composition according to claim 1, comprising mixing the PET and/or PLA with at least one monomeric carbodiimide of formula (I) using solids metering and mixing units.

6. The process according to claim 5, wherein, in a preceding step, the carbodiimide of formula (I) is prepared by carbodiimidization of trisubstituted benzene isocyanates of formula (III) 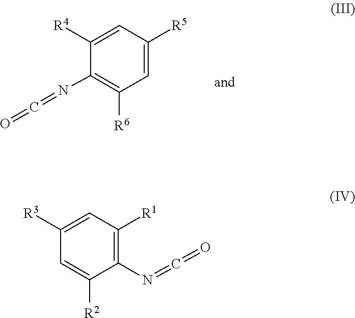
in which R¹ to R⁶ have the definitions given in claim 1,
with elimination of carbon dioxide at temperatures of 40° C. to 200° C. in the presence of catalysts and optionally solvents, followed by purification by distillation and/or extraction.

7. The process according to claim 6, the carbodiimide of formula (I) is purified by distillation and subsequent extraction.

8. A method of stabilizing hydrolysis of polyethylene terephthalate (PET) and/or polylactic acid (PLA) comprising the PET and/or PLA with a monomeric carbodiimide of formula (I) 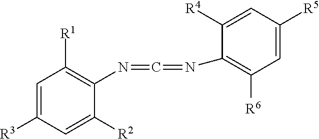
where R¹, R², R⁴ and R⁶=ethyl and
where R³, R⁵ are each independently C₁-C₆-alkyl.

9. The method according to claim 8, wherein R³ and R⁵ are t-butyl, i-propyl or methyl.

10. The method according to claim 8, wherein R³ and R⁵ are methyl.

11. The method according to claim 8, wherein 0.5-5% by weight of monomeric carbodiimides of the formula (I) is used, based on total amount of PET and/or PLA.

12. The method according to claim 8 further comprising producing a shaped body from the admixture of PET and/or PLA and monomeric carbodiimide of formula (I).

13. A shaped body comprising a composition according to claim 1.
